(19) United States
(12) Patent Application Publication
(10) Pub. No.: US 2022/0279781 A1
(43) Pub. Date: Sep. 8, 2022

(54) PROCESS FOR PRODUCING A LIQUID HERBICIDAL COMPOSITION

(71) Applicant: UPL LTD, Mumbai (IN)

(72) Inventors: Achintya Mondal, Mumbai (IN); Satish Ekanath Bhoge, Mumbai (IN)

(21) Appl. No.: 17/687,001

(22) Filed: Mar. 4, 2022

(30) Foreign Application Priority Data
Mar. 4, 2021 (IN) 202121009174

(51) Int. Cl. A01N 25/04; A01N 25/30; A01N 57/20

(52) U.S. Cl. CPC A01N 25/04; A01N 25/30; A01N 57/20

(57) ABSTRACT

The present invention relates to an improved process for producing a liquid herbicidal composition of single isomer of glufosinate salt. The present invention also provides a method of controlling unwanted plants using said herbicidal compositions.

### CROSS-REFERENCE TO RELATED APPLICATIONS

This application claims priority to Indian Application IN 202121009174 filed on Mar. 4, 2021, which is incorporated herein by reference in its entirety.

### TECHNICAL FIELD OF THE INVENTION

The present disclosure relates to a process for producing a liquid herbicidal composition of a glufosinate isomer or its salt. More particularly, the present disclosure relates to an improved process for producing a liquid herbicidal composition of L-glufosinate and/or its agronomically acceptable salts.

### BACKGROUND

Glufosinate is non-selective herbicide belonging to the group of organophosphate herbicides which has been widely used around the world. It is generally used in the form of an ammonium salt for total vegetation control and to control the growth of weeds and grasses. Glufosinate is used as a racemic mixture of L- and D-glufosinate. However, it is well known that L-glufosinate, i.e., (S)-2-amino-4-(hydroxy(methyl)phosphonyl)butanoic acid) is much more potent than D-glufosinate.

Many patents and non-patent literature related to compositions of L-glufosinate salt describe a general process for preparation of compositions comprising admixing the active ingredient with one or more adjuvants, such as diluents, extenders, carriers, surfactants, organic solvents, humectants, or conditioning agents, to provide a composition in the form of a finely-divided particulate solid, pellet, solution, dispersion, or emulsion. Most of these formulations are in water. However, these prior art references are silent regarding stepwise procedures carried out for production of a composition and the shortcomings faced during formulating the composition.

It is well known that glufosinate salt is readily soluble in water, however, while producing liquid herbicide compositions of L-glufosinate salt, the inventors of present invention noticed that L-glufosinate salt on contact with water forms a rock-solid lump which has low solubility. This rock-solid lump formation makes the process for producing a homogenous composition difficult and cumbersome. The inventors of the present invention have discussed these shortcomings in detail and have skillfully overcome them with an improved process for producing a liquid herbicidal composition of L-glufosinate salt.

### SUMMARY

Accordingly, it is an object of the present disclosure to provide a simple and improved process for producing a liquid herbicidal composition of a glufosinate isomer or its salt.

It is an object of the present disclosure to provide a simple and improved process for producing a liquid herbicidal composition of L-glufosinate or its salt.

It is another object of present disclosure to provide a process for producing a liquid herbicidal composition of an L-glufosinate salt, wherein the formation of a rock-solid lump is avoided.

It is yet another object of present disclosure to provide a simple, cost-effective and industrially viable process for producing a liquid herbicidal composition of L-glufosinate salt.

According to an aspect of the present disclosure, there is provided an improved process for producing a liquid herbicidal composition comprising:

admixing water with a dispersion, wherein the dispersion comprises single isomer of a glufosinate salt, and at least one organic solvent or a liquid surfactant.

According to another aspect of present disclosure, there is provided an improved process for producing a liquid herbicidal composition of an L-glufosinate salt comprising:

forming a dispersion in the absence of water, wherein the dispersion comprises the L-glufosinate salt and at least one organic solvent or a liquid surfactant; and

admixing the dispersion with water to obtain a liquid herbicidal composition which is free from rock-solid lumps.

According to another aspect of the present disclosure, there is provided an improved process for producing a liquid herbicidal composition of a single isomer of a glufosinate salt by avoiding the formation of rock-solid lump comprising:

admixing water with a dispersion, wherein the dispersion comprises the single isomer of the glufosinate salt and at least one organic solvent or a liquid surfactant.

In an embodiment, the dispersion does not contain water.

According to another aspect of present disclosure, there is provided an improved process for producing a liquid herbicidal composition of an L-glufosinate salt by avoiding the formation of a rock-solid lump, said process comprising:

admixing water with a dispersion, wherein the dispersion comprises the L-glufosinate salt and at least one organic solvent or a liquid surfactant.

In an embodiment, the dispersion does not contain water.

### DESCRIPTION OF THE FIGURES

FIG. 1 shows graphical presentation of the rock-solid lump formed when the conventional approach was used for producing a liquid herbicidal composition.

### DETAILED DESCRIPTION

Those skilled in art will be aware that invention described herein is subject to variations and modifications other than those specifically described. It is to be understood that the invention described herein includes all such variations and modifications. The invention also includes all such steps, features, compositions and methods referred to or indicated in this specification, individually or collectively, and any and all combinations of any two or more said steps or features.

### Definitions

For convenience, before further description of the present invention, certain terms employed in the specification, examples are described here. These definitions should be read in light of the remainder of the disclosure and understood as by a person of skill in the art. Unless defined otherwise, all technical and scientific terms used herein have the same meaning as commonly understood by a person of ordinary skill in the art. The terms used throughout this specification are defined as follows, unless otherwise limited in specific instances.

The terms used herein are defined as follows.

As used herein, “a,” “an,” “the,” and “at least one” do not denote a limitation of quantity and are intended to cover both the singular and plural, unless the context clearly indicates otherwise. For example, “an element” has the same meaning as “at least one element,” unless the context clearly indicates otherwise. The terms first, second etc. as used herein are not meant to denote any particular ordering, but simply for convenience to denote a plurality of, for example, layers. As used herein, the terms “comprising” “including,” “having,” “containing,” “involving,” and the like are to be understood to be open-ended, i.e., to mean “including” but not limited to, unless otherwise noted. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

In any aspect or embodiment described hereinbelow, the phrase comprising may be replaced by the phrases “consisting of” or “consisting essentially of” or “consisting substantially of.” In these aspects or embodiment, the composition described includes or comprises, or consists of, or consists essentially of, or consists substantially of the specific components recited therein, to the exclusion of other ingredients or excipients not specifically recited therein.

As used herein the term “composition” is used interchangeably with the term “formulation.”

The term “room temperature” unless stated otherwise, essentially means temperature in range of 20-35° C.

The term “dispersion” unless stated otherwise, essentially means system in which distributed particles of active ingredient are dispersed in a continuous phase of another material. The term ‘dispersion’ is used interchangeably with the term “slurry.”

The term “processing time” unless stated otherwise, essentially means the time required for completing a process of preparation of finished formulation from raw material.

Glufosinate has the chemical name 2-amino-4-[hydroxy(methyl)phosphoryl]butanoic acid. L-glufosinate, also known commercially as glufosinate-P, an isomer of glufosinate.

The inventors found that even though racemic glufosinate salt is readily soluble in water, the same was not true for a single isomer of a glufosinate salt.

It was observed that while preparing a soluble liquid formulation of L-glufosinate salt, when the L-glufosinate salt is brought into contact with water, the solubility of L-glufosinate drastically reduced due to formation of a rock-solid lump. This unpredicted decrease in solubility and formation of a rock-solid lump not only increases the processing time required to obtain the final product, but also can damage the equipment used for preparing said formulation. Thus, rock-solid lump formation makes large-scale production time consuming, cumbersome, and hence, high-priced.

On further investigation, it was found that the formulation prepared using this rock-solid lump may lead to uneven distribution on plant surfaces, thereby adversely impacting the bioavailability and efficiency of the formulation prepared. Hence, it was desirable to develop a process wherein, during processing of formulation, the solubility of the L-glufosinate is not affected and the soluble liquid composition is prepared more quickly and with more uniformity.

The inventors skillfully designed a process for producing a liquid herbicidal composition wherein the formation of a rock-solid lump is avoided to a great extent. In addition, the processing is not only fast, but also reliable and inexpensive.

According to an aspect, there is provided an improved process for producing a liquid herbicidal composition comprising:

admixing water with a dispersion, wherein the dispersion comprises a single isomer of a glufosinate salt, and at least one organic solvent or a liquid surfactant.

In an embodiment, the dispersion is substantially free of water, or does not contain water. As used herein, the term substantially free means less than 1 wt %, preferably less than 0.5 wt % and more preferably less than 0.1 wt % water.

In an embodiment, the process for producing a liquid herbicidal composition comprises forming a dispersion in the absence of water, wherein the dispersion comprises a single isomer of a glufosinate salt, and at least one organic solvent or a liquid surfactant.

In an embodiment, the dispersion comprises a single isomer of a glufosinate salt and at least one organic solvent.

In an embodiment, the single isomer of the glufosinate salt is an L-glufosinate salt or a D-glufosinate salt.

Exemplary salts include monosodium salt, disodium salt, monopotassium salt, dipotassium salt, calcium salt, ammonium salt, —NH3(CH3)+ salt, —NH2(CH3)2+ salt, —NH(CH3)3+ salt, —NH(CH3)2(C2H4OH)+ salt, —NH2(CH3)(C2H4OH)+ salt, and the like.

In an embodiment, the ammonium salt of L-glufosinate is used.

Exemplary solvents include water miscible polar/non-polar and a water immiscible polar/non-polar solvents, for example, alkyl esters of phthalic acid and trimellitic acid; aromatic hydrocarbons such as xylene, Solvesso™-100, Solvesso™-150, Solvesso™-200, alkyl benzenes; methylnaphthalene; mixtures of aromatics aliphatic or cycloaliphatic hydrocarbon such as hexanes and heptanes; phthalates; ketones such as cyclohexanone, 2-octanone or acetophenone, methyl isobutyl ketone, saturated or unsaturated cyclic ketones such as isophorone; chlorinated hydrocarbons; vegetable oils and modified vegetable oils; glycols and their derivatives; aliphatic alcohols, alkoxy aliphatic alcohols, and mixtures of such two or more solvents.

Additional solvents include alkylene carbonates (such as propylene carbonate), alkyl amides, and esters such as alkyl esters of monocarboxylic acids and dicarboxylic acid, esteramides, cyclic ethers such as furan, and its derivatives or mixtures thereof.

Additional solvents include vegetable oils such as castor oil and modified vegetable oils, glycols and their derivatives such as glycerin, propylene glycol, dipropylene glycol, polypropylene glycol, monoethylene glycol, diethylene glycol, polyethylene glycol 400, polyethylene glycol 300, polyethylene glycol 200, alkoxy aliphatic alcohols such as 1-methoxy-2-propanol, 2-butoxy ethanol, esters such as methyl ester of C8-C20 fatty acids or mixture thereof.

More preferably, the organic solvent used comprises glycerine, propylene glycol, diethylene glycol, polyethylene glycol 400, polyethylene glycol 300, polyethylene glycol 200, 1-methoxy-2-propanol, 2-butoxy ethanol, or a mixture thereof.

In an embodiment, the organic solvent used is propylene glycol.

In another embodiment, the organic solvent used is polyethylene glycol 300.

In yet another embodiment, the organic solvent used is 2-butoxy ethanol.

According to an embodiment, there is provided an improved process for producing a liquid herbicidal composition comprising admixing water with a dispersion, wherein the dispersion comprises L-glufosinate ammonium salt and propylene glycol.

According to an embodiment, there is provided an improved process for producing a liquid herbicidal composition comprising admixing water with a dispersion, wherein the dispersion comprises L-glufosinate ammonium salt and 2-butoxy ethanol.

According to an embodiment, there is provided an improved process for producing a liquid herbicidal composition comprising admixing water with a dispersion, wherein the dispersion comprises L-glufosinate ammonium salt and polyethylene glycol 300.

In another embodiment, more than one organic solvent is used.

According to an embodiment, there is provided an improved process for producing a liquid herbicidal composition comprising admixing water with a dispersion, wherein the dispersion comprises L-glufosinate ammonium salt, propylene glycol and 2-butoxy ethanol.

According to an embodiment, there is provided an improved process for producing a liquid herbicidal composition comprising admixing water with a dispersion, wherein the dispersion comprises L-glufosinate ammonium salt, propylene glycol, 2-butoxy ethanol, and polyethylene glycol 300.

In another embodiment, the dispersion comprises a single isomer of a glufosinate salt and a liquid surfactant.

Exemplary liquid surfactants are selected from anionic, cationic or zwitterionic and/or non-ionic surfactants.

Exemplary liquid surfactants include alcohol ethoxylate, alkyl ether phosphate, alkyl aryl ether phosphate, sulfosuccinate and its derivatives, and mixtures thereof.

According to an embodiment, there is provided an improved process for producing a liquid herbicidal composition comprising admixing water with a dispersion, wherein the dispersion comprises L-glufosinate ammonium salt and alkyl ether phosphate.

According to yet another embodiment, the process is carried out at temperature below 100° C., preferably at temperature of about 10° C. to 50° C.

According to yet another embodiment, the processing time required for obtaining the liquid herbicidal composition is less than 2 hours, preferably less than 1.5 hours.

According to another embodiment, there is provided a liquid herbicidal composition comprising

a) a single isomer of a glufosinate salt;

b) at least one organic solvent, or a liquid surfactant; and

c) water,

wherein the liquid herbicidal composition is prepared through an improved process comprising admixing the water with a dispersion; and wherein the dispersion comprises the single isomer of the glufosinate salt; and the at least one organic solvent or the liquid surfactant.

According to an embodiment, the liquid herbicidal composition comprises the single isomer of glufosinate salt in an amount from about 1% to about 95% (by weight), preferably from about 5% to 50% (by weight) of the total weight of the liquid herbicidal composition.

According to an embodiment, the liquid herbicidal composition comprises the organic solvent(s) in an amount from about of 1% about 40% (by weight), preferably from about 1% to 30% (by weight) of the total weight of the liquid herbicidal composition.

According to an embodiment, liquid herbicidal composition comprises the surfactant(s) in an amount from about 1% to about 60% (by weight), preferably from about 10% to 50% (by weight) of the total weight of the liquid herbicidal composition.

According to yet another embodiment, there is provided a liquid herbicidal composition comprising

a) L-glufosinate ammonium salt;

b) at least one organic solvent; and

c) water,

wherein the said liquid herbicidal composition is prepared through an improved process comprising admixing the water with a dispersion; and wherein the dispersion comprises the L-glufosinate ammonium salt and the at least one organic solvent.

According to yet another embodiment, there is provided a liquid herbicidal composition comprising

a) L-glufosinate ammonium salt;

b) at least one organic solvent; and

c) water,

wherein the liquid herbicidal composition is prepared through an improved process comprising admixing water with a dispersion; and wherein the dispersion comprises the L-glufosinate ammonium salt and the at least one organic solvent, wherein the at least one organic solvent is selected from group consisting of glycerine, propylene glycol, diethylene glycol, polyethylene glycol 400, polyethylene glycol 300, polyethylene glycol 200, 1-methoxy-2-propanol, 2-butoxy ethanol, and mixtures thereof.

According to another embodiment, there is provided a liquid herbicidal composition comprising

a) L-glufosinate ammonium salt;

b) a liquid surfactant; and

c) water,

wherein the liquid herbicidal composition is prepared through an improved process comprising admixing water with a dispersion; and wherein the dispersion comprises the L-glufosinate ammonium salt and the liquid surfactant.

According to another embodiment, there is provided a liquid herbicidal composition comprising

a) L-glufosinate ammonium salt;

b) a liquid surfactant;

c) water,

wherein the liquid herbicidal composition is prepared through an improved process comprising admixing water with a dispersion; and wherein the dispersion comprises the L-glufosinate ammonium salt and the liquid surfactant, wherein the liquid surfactant is selected from the group consisting of alcohol ethoxylate, alkyl ether phosphate, alkyl aryl ether phosphate, sulfosuccinate and its derivatives, and mixtures thereof.

According to another aspect, there is provided an improved process for producing a liquid herbicidal composition comprising a single isomer of glufosinate salt by avoiding the formation of a rock-solid lump, said process comprising:

admixing water with a dispersion, wherein the dispersion comprises a single isomer of a glufosinate salt, and at least one organic solvent or a liquid surfactant.

In an embodiment, the dispersion is substantially free of water, or does not contain water.

In an embodiment, the single isomer of a glufosinate salt is an L-glufosinate salt or D-glufosinate salt.

According to another aspect, there is provided an improved process for producing a liquid herbicidal composition of an L-glufosinate salt by avoiding the formation of a rock-solid lump, said process comprising:

admixing water with a dispersion, wherein the dispersion comprises the L-glufosinate salt, and at least one organic solvent or a liquid surfactant.

In an embodiment, the dispersion is substantially free of water, or does not contain water.

According to an embodiment, the L-glufosinate salt comprises the ammonium salt, monosodium salt, disodium salt, monopotassium salt, dipotassium salt, calcium salt, or the like.

In yet another embodiment, the L-glufosinate salt used is the L-glufosinate ammonium salt.

According to an embodiment, the L-glufosinate salt is mixed with at least one organic solvent to obtain a dispersion, and the dispersion is either added to water or water is added to the dispersion to obtain the desired liquid herbicidal composition.

According to an embodiment, the L-glufosinate salt is mixed with at least one liquid surfactant in the absence of water to obtain a dispersion, and the dispersion is either added to water or water is added to the dispersion to obtain the desired liquid herbicidal composition.

In an embodiment, the dispersion is substantially free of water, or does not contain water.

The process described herein does not involve any direct contact of L-glufosinate salt with water and therefore the formation of a rock-solid lump is avoided. This is done by preparing a dispersion of L-glufosinate salt with an organic solvent or liquid surfactant first in the absence of water. Thus, the method does not include contacting the L-glufosinate salt with water in the initial phase.

Furthermore, said dispersion is either added to water or water is added to the dispersion to obtain the desired liquid herbicidal composition.

This change in sequence of addition reduced the investment in time and equipment, thus the cost of production on large scale is also reduced.

According to another aspect, there is provided an improved process for producing a liquid herbicidal composition, said process comprising, admixing water with a dispersion, wherein the dispersion comprises a D-glufosinate salt, and at least one organic solvent or a liquid surfactant.

In an embodiment, the dispersion is substantially free of water, or does not contain water.

According to an embodiment, the D-glufosinate salt used is the ammonium, potassium, calcium, or sodium salt.

According to an embodiment, the liquid herbicidal composition further comprises another active ingredient selected from fungicides, insecticides, herbicides, plant regulators, defoliants, desiccants, biostimulants and nitrogen stabilizers, preferably with herbicides or mixtures thereof.

According to an embodiment, another active ingredient is herbicide.

Exemplary herbicides include, but are not limited to, diphenyl ether herbicides such as oxyfluorfen, acifluorfen and its salts, lactofen and its salts, fomesafen and its salts; pyrimidinyloxybenzoic analogue herbicides such as pyrithiobac sodium, bispyribac sodium; organophosphrous based herbicides such as glyphosate and its salts, bilanafos and its salts, bialaphos and its salts; bipyridinium herbicides such as paraquat and diquat and salts thereof; aryloxyalkanoic acid herbicides such as 2, 4-D and its salts and esters, 2-methyl-4-chlorophenocyacetic acid (MCPA), 4-(4-chloro-o-tolyloxy butyric acid) (MCPB) and their salts; aryloxyphenoxypropionic herbicides such as haloxyfop, isomers and esters, clodinafop and its esters; pyridine herbicides such as triclopyr, picloram, aminopyralid and salts thereof; aromatic herbicides such as dicamba, 2,3,6-trichrorobenzoic acid (2,3,6-TBA), tricamba and their salts; Pyridinecarboxylic acid herbicides such as clopyralid; imidazolinones selected from imazameth, imazamethabenz, imazamox, imazapic, imazapyr, imazaquin, imazethapyr; herbicides such as sulfonyl urea herbicides such as flazasulfuron, rimsulfuron, bensulfuron, ethoxysulfuron, mesosulfuron, oxasulfuron, pyrazosurfuron-ethyl and their salts; cyclohexanedioneoxime herbicides such as clethodim and its salts, chloroacetamide herbicide such as metolachlor and its salts and isomers, phenyl phthalimide herbicides such as flumioxazin and its salts, mesotrione, dinitroaniline herbicides such as oryzalin, pendimethalin, profluralin, trifluralin and its salts, bicyclic dicarboxylic acid herbicides such as endothal and its salts or mixtures of such herbicides.

According to another embodiment, the liquid herbicidal composition comprises another active ingredient such as an herbicide in an amount from about 1% to about 60% (by weight) of the total weight of the liquid herbicidal composition.

According to an embodiment, there is provided an improved process for producing a liquid herbicidal composition comprising:

admixing water with a dispersion wherein said dispersion comprises

a single isomer of a glufosinate salt;

at least one organic solvent or a liquid surfactant; and

another active ingredient selected from fungicides, insecticides, herbicides, plant regulators, defoliants, desiccants, biostimulants and nitrogen stabilizers, and mixtures thereof.

According to an embodiment, there is provided an improved process for producing a liquid herbicidal composition comprising:

admixing water with a dispersion wherein said dispersion comprises

a single isomer of aglufosinate salt;

at least one organic solvent or a liquid surfactant; and

another herbicide.

According to another embodiment, there is provided an improved process for producing a liquid herbicidal composition comprising:

admixing water with a dispersion wherein said dispersion comprises

a single isomer of a glufosinate salt;

at least one organic solvent or a liquid surfactant; and

another herbicide selected from the group consisting of, but not limited to, aryloxyalkanoic acid herbicides such as 2, 4-D and its salts and esters, MCPA, MCPB and their salts; an organophosphrous based herbicides such as glyphosate and its salts, bialaphos and its salts and the like.

According to an embodiment, the composition prepared by the present process may further comprise other agronomically suitable excipients such as surfactants, solvents, fertilizers, pH modifiers, crystallization inhibitors, viscosity modifiers, suspending agents, spray droplet modifiers, pigments, antioxidants, foaming agents, light-blocking agents, compatibilizing agents, antifoam agents, sequestering agents, neutralizing agents, corrosion inhibitors, dyes, odorants, spreading agents, penetration aids, micronutrients, emollients, lubricants, sticking agents, dispersing agents, thickening agents, freezing point depressants, antimicrobial agents, and the like.

According to an embodiment, the dispersion comprising a single isomer of a glufosinate salt and at least one organic solvent further comprises a surfactant.

Exemplary surfactants include anionic, cationic or zwitterionic and/or non-ionic surface-active compounds (surfactants), and combinations thereof.

Examples of anionic surfactants include anionic derivatives of fatty alcohols having 10-24 carbon atoms in the form of ether carboxylates, sulfonates, sulfates, and phosphates, and their inorganic salts (e.g., alkali metal and alkaline earth metal salts) and organic salts (e.g., salts based on amine or alkanolamine); anionic derivatives of copolymers consisting of EO (ethylene oxide), PO (propylene oxide) and/or BO (butylene oxide) units, in the form of ether carboxylates, sulfonates, sulfates, and phosphates, and their inorganic salts (e.g., alkali metal and alkaline earth metal salts) and organic salts (e.g., salts based on amine or alkanolamine); derivatives of alkylene oxide adducts of alcohols, in the form of ether carboxylates, sulfonates, sulfates and phosphates, and their inorganic salts (e.g., alkali metal and alkaline earth metal salts) and organic salts (e.g., salts based on amine or alkanolamine); derivatives of fatty acid alkoxylates, in the form of ether carboxylates, sulfonates, sulfates and phosphates, and their inorganic salts (e.g., alkali metal and alkaline earth metal salts) and organic salts (e.g., salts based on amine or alkanolamine); alkyl ether phosphate, sulfosuccinate and its derivatives, sulfosuccinate half ester, alkyl sulfosuccinate mono ester, diester salts, and combinations thereof.

Examples of cationic or zwitterionic surfactants may be selected from alkylene oxide adducts of fatty amines, quaternary ammonium compounds having 8 to 22 carbon atoms (C8-C22), surface-active zwitterionic compounds such as taurides, betaines and sulfobetaines.

Examples of non-ionic surfactants include alkylpolyglycosides, alkyl glucamide, alkyl amine oxides having C8 to C20 carbon atoms, alcohol ethoxylate, fatty acid methyl ester, sorbitan ester and ethoxylated sorbitan ester, ethoxylated alkylphenol, ethoxylated tristyrylphenol and alkyl amide, fatty alcohols having 10-24 carbon atoms with 0-60 EO and/or 0-20 PO and/or 0-15 BO in any order; fatty acid alkoxylates and triglyceride alkoxylates; fatty acid amide alkoxylates; alkylene oxide adducts of alkynediols; sugar derivatives such as amino sugars and amido sugars; polyacrylic and polymethacrylic derivatives; polyamides such as modified gelatins or derivatized polyaspartic acid; surfactant polyvinyl compounds such as modified PVP; polyol-based alkylene oxide adducts; polyglycerides and derivatives thereof.

In an aspect, provided herein is the use of the present composition as an herbicide to control harmful/undesired plants.

In an embodiment, provided is the use of liquid composition comprising L-glufosinate or its salts and/or other herbicide optionally with other auxiliary ingredients to control harmful/undesired plants.

The abovementioned compositions provide effective weed control to keep agricultural crops free from undesired competing plants and thus to safeguard and/or increase the yields from the qualitative and quantitative point of view.

The compositions described herein may be used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., tea, nut and vine crops, crops such as coconut, coffee, cocoa trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, and the like

The target weeds may be selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morning glory, IAQTA), Ipomoea hederacea (ivyleaf morning glory, IPOHE), Ipomoea lacunosa (white morning glory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE) or Xanthium strumarium (common cocklebur, XANST).

In another embodiment, a method of controlling undesired plants comprises applying the present compositions comprising L-glufosinate prepared according to the present disclosure.

In an embodiment, the compositions may be applied to the locus of a plant or crop either simultaneously or sequentially, such that the herbicide may be applied in a tank mix or as a pre-mixed composition.

In an embodiment, the present composition may be applied to either pre or post emergent harmful plants.

The method of control may be carried out by spraying the tank mixes, or the individual herbicides may be formulated as a kit-of-parts containing various components that may be mixed as instructed prior to spraying.

According to an embodiment, there is provided a kit comprising present liquid composition as an herbicide to control harmful plants.

The process for producing a liquid herbicidal composition according to the invention is ascertained by the experiments as exemplified below. These examples are merely illustrations and are not to be understood as limiting the scope and underlying principles of the invention in any way. Indeed, various modifications of the invention in addition to those shown and described herein will become apparent to those skilled in the art from the following examples and foregoing description.

### EXAMPLES

### Example 1

A liquid herbicidal composition in accordance with an embodiment of the present disclosure was prepared:

| Ingredients | Composition (% w/w) |
|---|---|
| L-glufosinate ammonium | 25.77 |
| Propylene glycol | 17 |
| 2-butoxy ethanol | 6.0 |
| Potassium chloride | 0.5 |
| Alkyl polyglucoside | 12 |
| Alkyl ether phosphate | 12 |
| Alkyl amine oxide | 24 |
| Water | Q.S. |
| Total | 100 |

L-glufosinate ammonium, propylene glycol and 2-butoxy ethanol were mixed under slow agitation in formulation vessel to obtain a dispersion. To the dispersion was then added alkyl polyglucoside, alkyl ether phosphate, alkyl amine oxide and potassium chloride. To the resultant mixture, water was added and the mixture was agitated for 90 minutes at 20-35° C. to provide a clear homogenous liquid herbicidal composition.

### Example 2

A liquid herbicidal composition in accordance with an embodiment of the present disclosure was prepared:

| Ingredients | Composition (% w/w) |
|---|---|
| L-glufosinate ammonium | 13.7 |
| Propylene Glycol | 17 |
| 2-butoxy ethanol | 6.0 |
| Potassium chloride | 0.5 |
| Alkyl polyglucoside | 15 |
| Water | Q.S. |
| Total | 100 |

L-glufosinate ammonium, propylene glycol and 2-butoxy ethanol were mixed under slow agitation at 20-35° C. for 10-30 minutes in formulation vessel to obtain a dispersion. To the dispersion was then added alkyl polyglucoside and potassium chloride. To the resultant mixture water was added and the mixture was agitated for 90 minutes at 20-35° C. to provide a clear homogenous liquid herbicidal composition.

### Example 3

A liquid herbicidal composition in accordance with an embodiment of the present disclosure was prepared:

| Ingredients | Composition (% w/w) |
|---|---|
| L-glufosinate ammonium | 13.7 |
| Propylene glycol | 20 |
| 2-butoxy ethanol | 4.5 |
| Potassium chloride | 0.5 |
| Alkyl amine oxide | 24 |
| Water | Q.S. |
| Total | 100 |

The composition was prepared according to process provided in Example 1 or 2.

### Example 4

A liquid herbicidal composition in accordance with an embodiment of the present disclosure was prepared:

| Ingredients | Composition (% w/w) |
|---|---|
| L-glufosinate ammonium | 18.7 |
| PEG 300 | 3.0 |
| Propylene glycol | 17.0 |
| 2-butoxy ethanol | 5.0 |
| Potassium chloride | 1.25 |
| Alkyl polyglucoside | 15 |
| Water | Q.S. |
| Total | 100 |

L-glufosinate ammonium and propylene glycol were mixed under slow agitation at 20-35° C. for 10-30 minutes in formulation vessel to obtain a dispersion. To the dispersion was then added PEG 300, 2-butoxy ethanol, alkyl polyglucoside and potassium chloride. To the resultant mixture water was added and the mixture was agitated for 90 minutes at 20-35° C. to obtain a clear homogenous liquid herbicidal composition.

### Example 5

A liquid herbicidal composition in accordance with an embodiment of the present disclosure was prepared:

| Ingredients | Composition (% w/w) |
|---|---|
| L-glufosinate ammonium | 13.7 |
| Propylene glycol | 20 |
| 2-butoxy ethanol | 4.5 |
| Potassium chloride | 0.5 |
| Alkyl ether phosphate | 15 |
| Water | Q.S. |
| Total | 100 |

L-glufosinate ammonium and alkyl ether phosphate were mixed under slow agitation at 20-35° C. for 10-30 minutes in formulation vessel to obtain a dispersion. To the dispersion was then added propylene glycol, 2-butoxy ethanol and potassium chloride. To the resultant mixture water was added and the mixture was agitated for 90 minutes at 20-35° C. to obtain a clear homogenous liquid herbicidal composition.

### Example 6

A liquid herbicidal composition in accordance with an embodiment of the present disclosure was prepared:

| Ingredients | Composition (% w/w) |
|---|---|
| L-glufosinate ammonium | 14.06 |
| Propylene glycol | 17 |
| 2-butoxy ethanol | 6.0 |
| Potassium chloride | 0.5 |
| Alkyl polyglucoside | 15 |
| Water | QS. |
| Total | 100 |

L-glufosinate ammonium, propylene glycol and 2-butoxy ethanol were mixed under slow agitation at 20° C. for 10-30 minutes in formulation vessel to obtain a dispersion. To the dispersion was then added alkyl polyglucoside and potassium chloride. To the resultant mixture water was added and the mixture was agitated for 120 minutes at 20° C. to obtain a clear homogenous liquid herbicidal composition.

### Example 7

A liquid herbicidal composition in accordance with and embodiment of the present disclosure was prepared:

| Ingredients | Composition (% w/w) |
|---|---|
| L-glufosinate ammonium | 14.06 |
| Propylene glycol | 20 |
| Potassium chloride | 0.5 |
| Alkyl ether phosphate | 15 |
| Water | Q.S. |
| Total | 100 |

### Method A

L-glufosinate ammonium and propylene glycol were mixed under slow agitation at 35° C. for 10-30 minutes in formulation vessel to obtain a dispersion. To the dispersion was then added alkyl ether phosphate and potassium chloride. To the resultant mixture water was added and the mixture was agitated for 120 minutes at 35° C. to obtain clear homogenous liquid herbicidal composition.

### Method B

L-glufosinate ammonium and alkyl ether phosphate were mixed under slow agitation at 35° C. for 10-30 minutes in formulation vessel to obtain a dispersion. To the dispersion was then added propylene glycol and potassium chloride. To the resultant mixture water was added and the mixture was agitated for 120 minutes at 35° C. to obtain a clear homogenous liquid herbicidal composition.

### Example 8

A liquid herbicidal composition in accordance with an embodiment of the present disclosure was prepared:

| Ingredients | Composition (% w/w) |
|---|---|
| L-glufosinate ammonium | 19.27 |
| polyethylene glycol 300 | 3.0 |
| Propylene glycol | 17 |
| 2-butoxy ethanol | 5.0 |
| Potassium chloride | 1.25 |
| Alkyl glucamide | 20 |
| Water | Q.S. |
| Total | 100 |

L-glufosinate ammonium, polyethylene glycol 300, propylene glycol and 2-butoxy ethanol were mixed under slow agitation at 35° C. for 10-30 minutes in formulation vessel to obtain a dispersion. To the dispersion was then added alkyl glucamide and potassium chloride. To the resultant mixture water was added and the mixture was agitated for 120 minutes at 35° C. to obtain a clear homogenous liquid herbicidal composition.

### Example 9

A liquid herbicidal composition in accordance with an embodiment of the present disclosure was prepared:

| Ingredients | Composition (% w/w) |
|---|---|
| L-glufosinate ammonium | 14.06 |
| Propylene glycol | 17 |
| 2-butoxy ethanol | 6 |
| Potassium chloride | 0.5 |
| Alkyl polyglucoside | 15 |
| Water | Q.S. |
| Total | 100 |

L-glufosinate ammonium, propylene glycol and 2-butoxy ethanol were mixed under slow agitation at 40° C. for 10-30 minutes in formulation vessel to obtain a dispersion. To the dispersion was then added alkyl polyglucoside and potassium chloride. To the resultant mixture water was added and the mixture was agitated for 60 minutes at 40° C. to obtain a clear homogenous liquid herbicidal composition

### Example 10

A liquid herbicidal composition in accordance with present disclosure was prepared:

| Ingredients | Composition (% w/w) |
|---|---|
| L-glufosinate ammonium | 14.06 |
| Propylene glycol | 20 |
| 2-butoxy ethanol | 4.50 |
| Potassium chloride | 0.5 |
| Alkyl amine oxide | 24 |
| Water | Q.S. |
| Total | 100 |

L-glufosinate ammonium, propylene glycol and 2-butoxy ethanol were mixed under slow agitation for 10-30 mins at 35° C. to obtain a dispersion. To the dispersion was then added alkyl amine oxide and potassium chloride under agitation. To the resultant mixture water was added and the mixture was agitated for 120 mins at 35° C. to obtain a clear homogenous liquid herbicidal composition

### Example 11

A liquid herbicidal composition in accordance with an embodiment of the present disclosure was prepared:

| Ingredients | Composition (% w/w) |
|---|---|
| L-glufosinate ammonium | 19.27 |
| Propylene glycol | 20 |
| Water | Q.S. |
| Total | 100 |

L-glufosinate ammonium and propylene glycol were mixed under slow agitation at 35° C. for 10-30 minutes in formulation vessel to obtain a dispersion. To the dispersion was then added water and the mixture was agitated for 120 minutes at 35° C. to obtain a clear homogenous liquid herbicidal composition.

### Example 12

A liquid herbicidal composition in accordance with an embodiment of the present disclosure was prepared:

| Ingredients | Composition (% w/w) |
|---|---|
| L-glufosinate ammonium | 26.04 |
| Alkyl ether phosphate | 25 |
| Water | Q.S. |
| Total | 100 |

L-glufosinate ammonium and alkyl ether phosphate were mixed under slow agitation at 20-35° C. for 10-30 minutes in formulation vessel to obtain a dispersion. To the dispersion was then added water and the mixture was agitated for 120 minutes at 35° C. to obtain a clear homogenous liquid herbicidal composition.

### Example 13 & 14

A liquid herbicidal composition in accordance with an embodiment of the present disclosure was prepared:

| | Composition (% w/w) | |
|---|---|---|
| Ingredients | Example 13 | Example 14 |
| 2,4-D amine salt | — | 18 |
| Glyphosate IPA salt | 15 | — |
| L-Glufosinate ammonium (Technical | 14.2 | 18 |
| 96%) | | |
| Alkyl ether phosphate | 15 | 15 |
| Alkyl polyglucoside | 8 | 10 |
| C₁₀ alkylamine oxide | 10 | 10 |
| C₁₃-C₁₅ alkyl amine oxide | 10 | — |
| Propylene glycol | 17 | 15 |
| Potassium chloride | 0.25 | 0.25 |
| 2-butoxy ethanol | 10 | 10 |
| Water | Q.S. | Q.S. |
| Total | 100 | 100 |

L-glufosinate ammonium and alkyl ether phosphate were mixed under slow agitation in formulation vessel to obtain a dispersion. To the dispersion, alkyl polyglucoside, alkyl amine oxide, propylene glycol, 2-butoxy ethanol and potassium chloride were added followed by addition of 2,4-D amine or glyphosate IPA. To the resultant mixture water was added and the mixture was agitated for 100 minutes at 20-35° C. to obtain a clear homogenous liquid herbicidal composition.

### Comparative Example 1

In order to demonstrate the advantages of the inventive process, the formulation provided in Example 1 was prepared by using conventional process (U.S. Pat. No. 5,491,125).

L-glufosinate ammonium was added to water under agitation in formulation vessel. At this stage, it was observed that rock-solid lump was formed and the solubility of L-glufosinate ammonium salt decreased drastically. To this mixture was then added propylene glycol, 2-butoxy ethanol, alkyl polyglucoside, alkyl ether phosphate, alkyl amine oxide and potassium chloride under agitation. The mixture required agitation for 200 minutes at 20-35° C. to get clear homogenous liquid herbicidal composition.

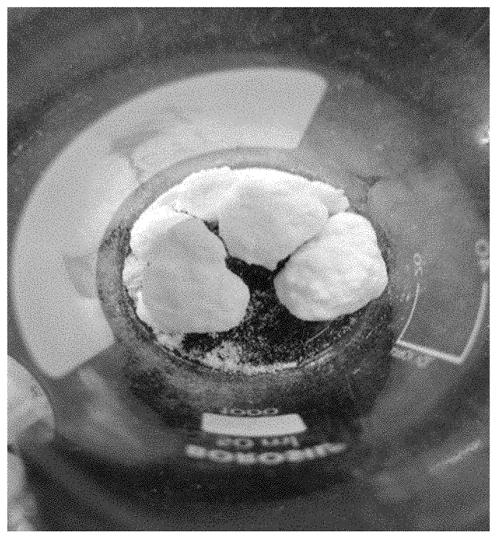

FIG. 1 depicts a photograph of the rock-solid lump obtained during the process.

It was observed that the processing time for production of composition is dependent on the solubility of L-glufosinate salt. When the conventional process is followed, L-glufosinate salt is first contacted with water and the processing time for production of formulation is increased from 90 minutes to 200 minutes. The present disclosure mainly provides solution to these three problems namely,

1. formation of rock-solid lump during formulating the finished product;

2. long processing time required due to reduced solubility of rock-solid lump formed; and

3. reduced bioavailability and efficiency of the formulation.

1. A process for producing a liquid herbicidal composition comprising:
admixing water with a dispersion wherein said dispersion comprises single isomer of glufosinate salt; and at least one organic solvent or a liquid surfactant.

2. The process as claimed in claim 1, wherein said dispersion is substantially free of water.

3. The process as claimed in claim 1, wherein said single isomer of glufosinate salt is L-glufosinate salt or D-glufosinate salt.

4. The process as claimed in claim 3, wherein said glufosinate salt used is selected from the group comprising of ammonium salt, monosodium salt, disodium salt, monopotassium salt, dipotassium salt or calcium salt.

5. The process as claimed in claim 1, wherein said dispersion comprises of single isomer of glufosinate salt and at least one organic solvent.

6. The process as claimed in claim 5, wherein said organic solvent is selected from a polar or a non-polar solvent.

7. The process as claimed in claim 5, wherein said organic solvent used is selected from the group comprising of glycerine, propylene glycol, diethylene glycol, polyethylene glycol 400, polyethylene glycol 300, polyethylene glycol 200, 1-methoxy-2-propanol, 2-butoxy ethanol or mixture thereof.

8. The process as claimed in claim 1, wherein said dispersion comprises of single isomer of glufosinate salt and a liquid surfactant.

9. The process as claimed in claim 8, wherein said liquid surfactant is selected from anionic, cationic, zwitterionic and/or non-ionic surfactants.

10. The process as claimed in claim 8, wherein said liquid surfactant is selected from the group comprising of alcohol ethoxylate, alkyl ether phosphate, alkyl aryl ether phosphate, sulfosuccinate and its derivatives, or mixtures thereof.

11. The process as claimed in claim 1, wherein the process is carried out at temperature below 100° C.

12. The process as claimed in claim 1, wherein the processing time required for obtaining the liquid herbicidal composition is less than 2 hours.

13. The process as claimed in claim 1, wherein said composition further comprises another active ingredient/s selected from fungicides, insecticides, herbicides, plant regulators, defoliants, desiccants, biostimulants and nitrogen stabilizers, or mixtures thereof.

14. The process as claimed in claim 13, wherein said another active ingredient is a herbicide.

15. A process for producing a liquid herbicidal composition of L-glufosinate salt comprising:
forming a dispersion in the absence of water wherein the dispersion comprises L-glufosinate salt and at least one organic solvent or a liquid surfactant; and
admixing the dispersion with water to obtain a liquid herbicidal composition free from rock-solid lumps.

16. A liquid herbicidal composition comprising:
a) single isomer of glufosinate salt;
b) at least one organic solvent; or a liquid surfactant; and
c) water
wherein the said liquid herbicidal composition is prepared through the process as claimed in claim 1.

17. The composition as claimed in claim 16 wherein said single isomer of glufosinate salt is L-glufosinate salt or D-glufosinate salt.
